(19) United States
(12) Patent Application Publication
(10) Pub. No.: US 2013/0184972 A1
(43) Pub. Date: Jul. 18, 2013

(54) AIR-FUEL RATIO CONTROL APPARATUS FOR INTERNAL COMBUSTION ENGINE AND CONTROL METHOD

(71) Applicants: Takashi Suzuki, Gotenba-shi (JP); Yoshikazu Asami, Gotenba-shi (JP)

(72) Inventors: Takashi Suzuki, Gotenba-shi (JP); Yoshikazu Asami, Gotenba-shi (JP)

(21) Appl. No.: 13/738,352

(22) Filed: Jan. 10, 2013

(30) Foreign Application Priority Data
Jan. 12, 2012 (JP) 2012-004243

(51) Int. Cl. F02D 41/30

(52) U.S. Cl. CPC F02D 41/30
USPC 701/104

(57) ABSTRACT

An air-fuel ratio control apparatus that is applied to an internal combustion engine having an intake passage to which a canister is connected via an evaporative fuel supply passage, and an exhaust passage that is provided with an exhaust gas purifier, includes a first sensor provided upstream of the exhaust gas purifier, a second sensor provided downstream of the exhaust gas purifier, and a controller that corrects a fuel injection amount through feedback on a basis of the air-fuel ratio acquired by the first sensor, modifies a correction coefficient used for feedback correction on a basis of the air-fuel ratio acquired by the second sensor, and has a storage unit that stores the modified correction coefficient. The controller prohibits the modified correction coefficient from being stored into the storage unit if a concentration of fuel in purge gas is equal to or higher than a predetermined criterial concentration.

### INCORPORATION BY REFERENCE

The disclosure of Japanese Patent Application No. 2012-004243 filed on Jan. 12, 2012 including the specification, drawings and abstract is incorporated herein by reference in its entirety.

### BACKGROUND OF THE INVENTION

1. Field of the Invention

The invention relates to an air-fuel ratio control apparatus for an internal combustion engine that corrects a fuel injection amount through feedback in accordance with an air-fuel ratio of exhaust gas and a control method.

2. Description of Related Art

There is known an air-fuel ratio control apparatus that corrects a fuel injection amount through feedback in accordance with an output signal of an air-fuel ratio sensor that is provided upstream of an exhaust gas purification catalyst such that the air-fuel ratio of exhaust gas becomes equal to a predetermined target air-fuel ratio, for example, a theoretical air-fuel ratio, and modifies a correction coefficient used for the feedback correction in accordance with an output signal of an air-fuel ratio sensor that is provided downstream of the exhaust gas purification catalyst. Besides, as such an air-fuel ratio control apparatus, there is known an apparatus that reduces the correction coefficient used for feedback correction as the concentration of fuel in purge gas introduced into an intake passage from a canister increases (see Japanese Patent Application Publication No. 08-177572 (JP-08-177572 A). Moreover, the related art documents related to the invention include Japanese Patent Application Publication No. 2002-030965 (JP-2002-030965 A) and Japanese Patent Application Publication No. 2005-315123 (JP-2005-315123 A).

In an internal combustion engine having a plurality of cylinders, due to the influence of the shape of an intake manifold or the like, purge gas is likely to be introduced into some cylinders but unlikely to be introduced into the other cylinders. In addition, exhaust gas discharged from that one of the cylinders into which purge gas is likely to be introduced (which may be referred to hereinafter as a specific cylinder) may become likely to hit an air-fuel ratio sensor located upstream of an exhaust gas purification catalyst, due to the influence of the shape of an exhaust manifold or the like. In such an internal combustion engine, when purge gas containing a high concentration of fuel is introduced into an intake passage, exhaust gas whose air-fuel ratio has greatly shifted toward the rich side hits the air-fuel ratio sensor located upstream. Thus, the output signal from the air-fuel ratio sensor located upstream greatly shifts toward the rich side. Accordingly, the fuel injection amount is corrected through feedback in an attempt to correct the air-fuel ratio excessively toward the lean side. However, although the air-fuel ratio of the exhaust gas that has hit the air-fuel ratio sensor located upstream has shifted toward the rich side, the air-fuel ratios of exhaust gases discharged from the cylinders other than the specific cylinder have not shifted toward the rich side as greatly as the air-fuel ratio of exhaust gas in the specific cylinder. Thus, an output signal that is on a learner side is output from the air-fuel ratio sensor provided downstream of the exhaust gas purification catalyst than from the air-fuel ratio sensor provided upstream of the exhaust gas purification catalyst. Thus, a correction coefficient is set such that the air-fuel ratio shifts toward the rich side in response to an excessive correction toward the lean side through feedback based on the air-fuel ratio sensor located upstream. Accordingly, in such an internal combustion engine, a wrong correction coefficient may be set when purge gas containing a high concentration of fuel is introduced. The apparatus of Japanese Patent Application Publication No. 08-177572 (JP-08-177572 A) does not take such an internal combustion engine into account.

### SUMMARY OF THE INVENTION

Thus, the invention provides an air-fuel ratio control apparatus for an internal combustion engine that can restrain a wrong value from being set as a correction coefficient that is used for feedback correction of an air-fuel ratio.

In a first aspect of the invention, there is provided an air-fuel ratio control apparatus that is applied to an internal combustion engine having an intake passage to which a canister capable of retaining evaporative fuel generated in a fuel tank is connected via an evaporative fuel supply passage, and an exhaust passage that is provided with an exhaust gas purifier. The air-fuel ratio control apparatus is equipped with a first sensor that is provided in the exhaust passage in a section upstream of the exhaust gas purifier to acquire an air-fuel ratio of exhaust gas, a second sensor that is provided in the exhaust passage in a section downstream of the exhaust gas purifier to acquire an air-fuel ratio of exhaust gas, and a controller that corrects a fuel injection amount of the internal combustion engine through feedback on the basis of the air-fuel ratio acquired by the first sensor, modifies a correction coefficient used for feedback correction on the basis of the air-fuel ratio acquired by the second sensor, and has a storage unit that stores the modified correction coefficient, and prohibits the modified correction coefficient from being stored into the storage unit if a concentration of fuel in purge gas introduced into the intake passage from the canister is equal to or higher than a predetermined criterial concentration.

According to the aforementioned configuration, if the concentration of fuel in purge gas (which may be referred to hereinafter as a purge concentration) is equal to or higher than the criterial concentration, the modified correction coefficient is prohibited from being stored. Therefore, the storage of a wrong correction coefficient into the storage unit, namely, the erroneous learning of a correction coefficient can be prevented. Thus, when a feedback correction is carried out using the correction coefficient stored in the storage unit, a wrong value can be restrained from being set as the correction coefficient. In addition, the exhaust emission properties of the internal combustion engine can thus be improved.

Besides, in the foregoing aspect of the invention, the controller may prohibit the correction coefficient from being modified if the concentration of fuel in purge gas introduced into the intake passage from the canister is equal to or higher than the criterial concentration. In this case, the correction coefficient is prohibited from being modified. Therefore, a wrong value can further be restrained from being set as the correction coefficient.

In a second aspect of the invention, there is provided an air-fuel ratio control apparatus that is applied to an internal combustion engine having an intake passage to which a canister capable of retaining evaporative fuel generated in a fuel tank is connected via an evaporative fuel supply passage, and an exhaust passage that is provided with an exhaust gas purifier. The air-fuel ratio control apparatus is equipped with a first sensor that is provided in the exhaust passage in a section upstream of the exhaust gas purifier to acquire an air-fuel ratio of exhaust gas, a second sensor that is provided in the exhaust passage in a section downstream of the exhaust gas purifier to acquire an air-fuel ratio of exhaust gas, and a controller that corrects a fuel injection amount of the internal combustion engine through feedback on the basis of the air-fuel ratio acquired by the first sensor, modifies a correction coefficient used for feedback correction on the basis of the air-fuel ratio acquired by the second sensor such that the air-fuel ratio acquired by the second sensor becomes equal to a predetermined target value, and has a storage unit that stores the modified correction coefficient. In this air-fuel ratio control apparatus, the controller restricts modification of the correction coefficient if a concentration of fuel in purge gas introduced into the intake passage from the canister is equal to or higher than a predetermined criterial concentration, the correction coefficient stored in the storage unit is the correction coefficient that is modified when the concentration of fuel in purge gas is lower than the criterial concentration, and a difference between the air-fuel ratio acquired by the second sensor and the target value is equal to or larger than a predetermined criterial value.

According to the aforementioned configuration, if the purge concentration is equal to or higher than the criterial concentration, the correction coefficient in the storage unit is the correction coefficient that is modified when the purge concentration is lower than the criterial concentration, and the difference between the air-fuel ratio acquired by the second sensor and the target value is equal to or larger than the criterial value, modification of the correction coefficient is restricted. Therefore, a wrong value can be restrained from being set as the correction coefficient. Thus, the fuel injection amount can be restrained from being erroneously corrected. Therefore, the exhaust emission properties of the internal combustion engine can be improved.

Besides, in the foregoing aspect of the invention, the controller may subject at least a deviation between the air-fuel ratio acquired by the second sensor and the target value to an integration processing to modify the correction coefficient, and restrict modification of the correction coefficient by restricting at least one of the number of times of the integration processing and an update amount that is added each time in the integration processing. In the case where the correction coefficient is modified in the integration processing, if at least one of the number of times of the integration processing and the update amount is thus restricted, modification of the correction coefficient can be restricted.

In a third aspect of the invention, there is provided a control method for an air-fuel ratio control apparatus that is applied to to an internal combustion engine having an intake passage to which a canister capable of retaining evaporative fuel generated in a fuel tank is connected via an evaporative fuel supply passage, and an exhaust passage that is provided with an exhaust gas purifier, and that is equipped with a first sensor that is provided in the exhaust passage in a section upstream of the exhaust gas purifier to acquire an air-fuel ratio of exhaust gas, and a second sensor that is provided in the exhaust passage in a section downstream of the exhaust gas purifier to acquire an air-fuel ratio of exhaust gas. In this control method, a fuel injection amount of the internal combustion engine through feedback is corrected on a basis of the air-fuel ratio acquired by the first sensor, a correction coefficient used for feedback correction is modified on a basis of the air-fuel ratio acquired by the second sensor such that the air-fuel ratio acquired by the second sensor becomes equal to a predetermined target value, the modified correction coefficient is stored a storage unit with, it is determined whether or not a concentration of fuel in purge gas introduced into the intake passage from the canister is equal to or higher than a predetermined criterial concentration, the correction coefficient stored in the storage unit is the correction coefficient that is modified when the concentration of fuel in purge gas is lower than the criterial concentration, and a difference between the air-fuel ratio acquired by the second sensor and the target value is equal to or larger than a predetermined criterial value, and modification of the correction coefficient is restricted if it is determined that the concentration of fuel in purge gas introduced into the intake passage from the canister is equal to or higher than the predetermined criterial concentration, the correction coefficient stored in the storage unit is the correction coefficient that is modified when the concentration of fuel in purge gas is lower than the criterial concentration, and the difference between the air-fuel ratio acquired by the second sensor and the target value is equal to or larger than the predetermined criterial value.

Besides, in the foregoing aspect of the invention, at least a deviation between the air-fuel ratio acquired by the second sensor and the target value may be subjected to an integration processing to modify the correction coefficient, and at least one of the number of times of the integration processing and an update amount that is added each time in the integration processing may be restricted.

According to the aforementioned configuration, an effect similar to that of the foregoing second aspect of the invention is obtained.

As described above, according to the air-fuel ratio control apparatus of the invention, a wrong value can be restrained from being set as the correction coefficient. Thus, the fuel injection amount can be restrained from being erroneously corrected. Therefore, the exhaust emission properties of the internal combustion engine can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view schematically showing an internal combustion engine in which an air-fuel ratio control apparatus according to the first embodiment of the invention is incorporated;

FIG. 2 is a flowchart showing a sub F/B restriction routine that is executed by an ECU;

FIG. 3 is a flowchart showing a sub F/B learning restriction routine that is executed by the ECU in the air-fuel ratio control apparatus according to the first embodiment of the invention; and

FIG. 4 is a view showing an example of how the output value of an O₂ sensor changes with time when a canister is purged.

### DETAILED DESCRIPTION OF EMBODIMENTS

(First Embodiment)

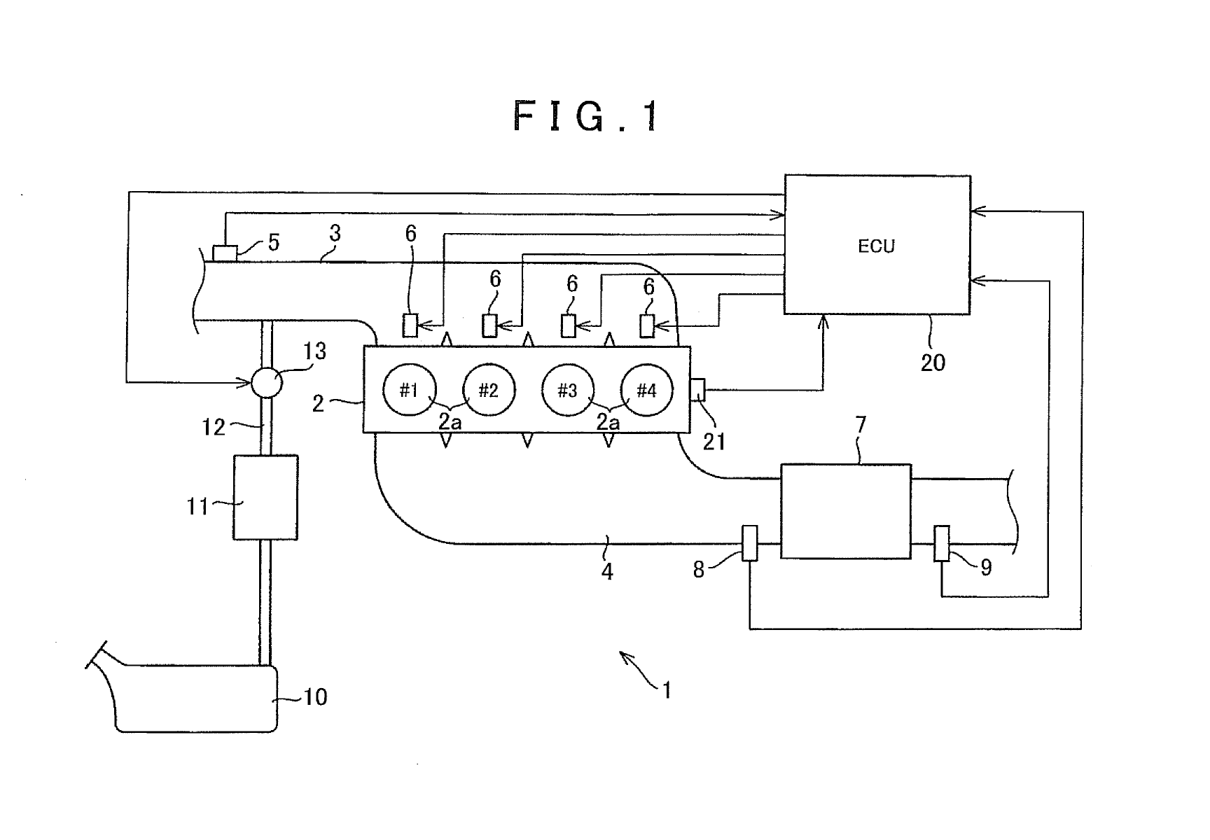

FIG. 1 schematically shows an essential part of an internal combustion engine in which an air-fuel ratio control apparatus according to the first embodiment of the invention is incorporated. This internal combustion engine (which may be referred to hereinafter as an engine) 1 is a well-known spark ignition-type internal combustion engine that is mounted on a vehicle as a motive power source for traveling. The engine 1 is equipped with an engine body 2 having a plurality of (four in FIG. 1) cylinders 2a, an intake passage 3, and an exhaust passage 4. Each of the intake passage 3 and the exhaust passage 4 is connected to the respective cylinders 2a. Cylinder numbers #1 to #4 are assigned to the respective cylinders 2a from one end to the other in the alignment direction thereof, so as to make a distinction among them. The intake passage 3 is provided with an airflow meter 5 that outputs a signal corresponding to an intake air amount. Besides, the intake passage 3 is provided with fuel injection valves 6 respectively for the cylinders 2a. The fuel injection valves 6 are provided at intake ports of the intake passage 3 that are connected to the cylinders 2a respectively. That is, this engine 1 is a port injection-type internal combustion engine having intake ports into which fuel is injected.

The exhaust passage 4 is provided with an exhaust gas purification catalyst 7 as an exhaust gas purifier that purifies exhaust gas. For example, a three-way catalyst or the like is employed as the exhaust gas purification catalyst 7. An air-fuel ratio sensor 8 as a first sensor is provided in the exhaust passage 4 in a section upstream of the exhaust gas purification catalyst 7. The air-fuel ratio sensor 8 is a well-known sensor that outputs a signal corresponding to an air-fuel ratio of exhaust gas. Besides, an O₂ sensor 9 as a second sensor is provided in the exhaust passage 4 in a section downstream of the exhaust gas purification catalyst 7. The O₂ sensor 9 is a well-known sensor that outputs a signal corresponding to a concentration of oxygen in exhaust gas. Thus, the detailed description of these sensors 8 and 9 is omitted.

The engine 1 is provided with a fuel tank 10. The fuel tank 10 leads to a canister 11 capable of adsorbing and retaining fuel vapors generated in the fuel tank 10. The canister 11 is a well-known canister that can adsorb and retain fuel components and discharges the retained fuel when air is introduced thereinto. Therefore, the detailed description of the canister 11 is omitted. Besides, the canister 11 is connected to the intake passage 3 via an evaporative fuel supply passage 12. The evaporative fuel supply passage 12 is provided with a control valve 13 that can open/close this passage 12. When the control valve 13 is opened, air is introduced into the canister 11 due to a negative pressure in the intake passage 3, and purge gas containing air and fuel is introduced into the intake passage 3 from the canister 11.

As shown in this drawing, in the engine 1, the cylinder 2a with the cylinder number #1 is closest to the evaporative fuel supply passage 12. Thus, purge gas introduced into the intake passage 3 from the canister 11 is likely to flow into the cylinder 2a with the cylinder number #1. Besides, in this engine 1, exhaust gas discharged from the cylinder 2a with the cylinder number #1 flows along a wall surface of the exhaust passage 4, and hits the air-fuel ratio sensor 8 hard. In this manner, in the engine 1, purge gas is likely to flow into a specific cylinder, namely, the cylinder 2a with the cylinder number #1, and exhaust gas discharged from the specific cylinder hits the air-fuel ratio sensor 8 hard.

The operations of the fuel injection valves 6 and the control valve 13 are controlled by an engine control unit (hereinafter referred to as an ECU) 20 as a controller. The ECU 20 is a computer unit that includes a microprocessor and peripheral components that are needed for the operation thereof, such as a RAM, a ROM and the like. The ECU 20 controls the engine 1 to a target operation state by controlling the operations of the fuel injection valves 6, the control valve 13 and the like according to a predetermined control program. Various sensors for making a determination on the operation state of the engine 1 are connected to the ECU 20. For example, a crank angle sensor 21 that outputs a signal corresponding to a rotational speed of a crankshaft is connected to the ECU 20. Besides, the aforementioned airflow meter 5, the aforementioned air-fuel ratio sensor 8, and the aforementioned O₂ sensor 9 are also connected to the ECU 20. Although various other sensors are connected to the ECU 20, they are not shown in the drawing.

Next, the control performed by the ECU 20 will be described. The ECU 20 opens the control valve 13 to purge the canister 11 upon fulfillment of a predetermined purge condition that is set in advance. For example, if the cumulative value of operation time of the engine 1 after last purge of the canister 11 exceeds a predetermined criterial time, it is determined that the purge condition is fulfilled.

Besides, the ECU 20 calculates an amount of fuel to be injected from each of the fuel injection valves 6 in accordance with an operation state of the engine 1, and controls the operation of each of the fuel injection valves 6 such that the calculated amount of fuel is injected therefrom. In calculating a fuel amount, the ECU 20 first calculates a basic fuel amount on the basis of an intake air amount and a rotational speed of the engine 1. Besides, the ECU 20 calculates a feedback correction coefficient (hereinafter referred to simply as a correction coefficient) such that the air-fuel ratio of exhaust gas introduced into the exhaust gas purification catalyst 7 becomes equal to a predetermined target air-fuel ratio, on the basis of an output signal from the air-fuel ratio sensor 8, and corrects the basic fuel amount on the basis of the calculated correction coefficient. This feedback correction may be referred to hereinafter as main feedback (main F/B). For example, a theoretical air-fuel ratio is set as the target air-fuel ratio. Furthermore, the ECU 20 modifies the aforementioned correction coefficient such that an output value from the O₂ sensor 9 becomes equal to a predetermined target value, on the basis of a difference between the output value of the O₂ sensor 9 and the target value. The modification of this correction coefficient may be referred to hereinafter as sub feedback (sub F/B). In sub F/B, the correction coefficient is modified by, for example, subjecting a deviation between the output value of the O₂ sensor 9 and the target value to a proportion/integration/differentiation processing, namely, a PID processing. For example, the value of an output signal that is output from the O₂ sensor 9 in the case where the air-fuel ratio of exhaust gas is equal to the theoretical air-fuel ratio is set as the target value. Then, the correction coefficient modified through sub F/B is stored into the RAM of the ECU 20, and is used to calculate a fuel amount thereafter. In this manner, the ECU 20 learns the correction coefficient. Incidentally, the basic fuel amount and the correction coefficient may be calculated according to a well-known method. Therefore, the detailed description of such a method is omitted. Since the RAM of the ECU 20 stores the correction coefficient in sub F/B, the ECU 20 is equivalent to the storage unit of the invention.

As described above, in the engine 1, purge gas is likely to flow into the cylinder 2a with the cylinder number #1. Besides, exhaust gas in the cylinder 2a with the cylinder number #1 hits the air-fuel ratio sensor 8 hard. The concentration of fuel in purge gas (which may be referred to hereinafter as a purge concentration) changes depending on the amount of fuel adsorbed and retained by the canister 11, and the purge concentration is high when a large amount of fuel is adsorbed and retained by the canister 11. When purge gas with a high purge concentration is introduced into the intake passage 3, the air-fuel ratio of the cylinder 2a with the cylinder number #1 shifts more toward the rich side than the air-fuel ratios of the other cylinders 2a. In addition, exhaust gas in the cylinder 2a with the cylinder number #1, whose air-fuel ratio has shifted toward the rich side, hits the air-fuel ratio sensor 8 hard. In main F/B, therefore, the basic fuel amount is corrected such that the air-fuel ratio shifts toward the lean side. On the other hand, exhaust gases in the four cylinders 2a are mixed with one another in the exhaust gas purification catalyst 7, and hit the O₂ sensor 9. Therefore, a signal that is on a leaner side than an output signal of the air-fuel ratio sensor 8 is output from the O₂ sensor 9. Accordingly, an attempt to modify the correction coefficient toward the rich side is made in sub F/B. In addition, this creates a possibility of a wrong correction coefficient being learned.

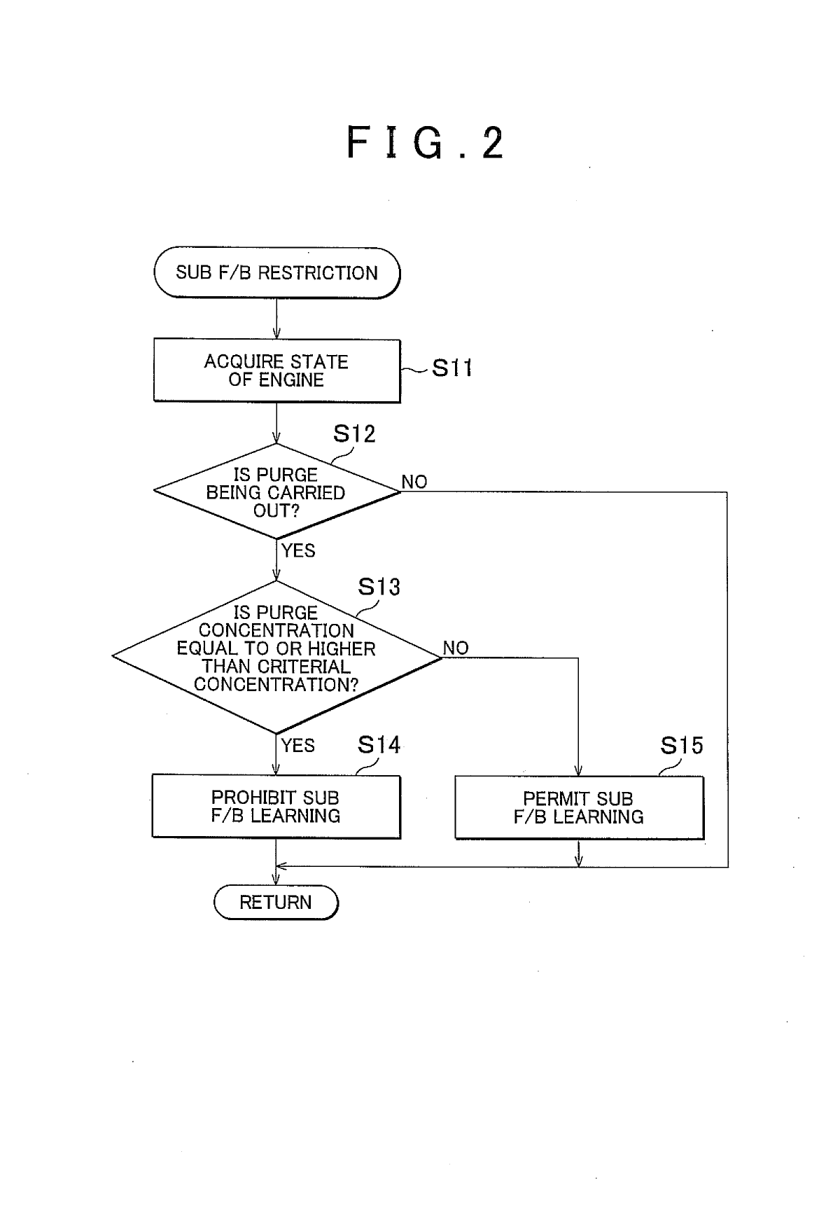

Thus, the ECU 20 executes a sub F/B restriction routine shown in FIG. 2 to prevent the erroneous learning of a correction coefficient. This routine is repeatedly executed on a predetermined cycle during the operation of the engine 1.

In this routine, first in step 511, the ECU 20 acquires an operation state of the engine 1. As the operation state, for example, a rotational speed of the engine 1, an intake air amount, an air-fuel ratio of exhaust gas upstream of the exhaust gas purification catalyst 7, a concentration of oxygen downstream of the exhaust gas purification catalyst 7 and the like are acquired. Besides, in this processing, information on whether or not the canister 11 is being purged at the moment is also acquired on the basis of the state of the control valve 13. Subsequently in step S12, the ECU 20 determines whether or not the canister 11 is being purged at the moment. If it is determined that the canister 11 is not being purged at the moment, the ECU 20 ends the current routine.

On the other hand, if it is determined that the canister 11 is being purged at the moment, the ECU 20 proceeds to step S13 to determine whether or not the purge concentration is equal to or higher than a predetermined criterial concentration that is set in advance. As described above, since the air-fuel ratio of exhaust gas shifts toward the rich side during the purge of the canister 11, the output signal of the air-fuel ratio sensor 8 and the output signal of the O₂ sensor 9 shift toward the rich side. Thus, it can be determined, on the basis of, for example, an output signal of the O₂ sensor 9, whether or not the purge concentration is equal to or higher than the criterial concentration. More specifically, it is appropriate to determine that the purge concentration is equal to or higher than the criterial concentration if the difference between an output value of the O₂ sensor 9 before purge and an output value of the O₂ sensor 9 after purge becomes equal to or larger than a criterial value that is set in advance. Incidentally, for example, an output value that does not make it really necessary to modify the correction coefficient on the basis of the output value of the O₂ sensor 9 in sub F/B is set as the criterial value.

If it is determined that the purge concentration is equal to or higher than the criterial concentration, the ECU 20 proceeds to step S14 to prohibit the correction coefficient modified through sub F/B from being learned, that is, to prohibit the correction coefficient from being stored into the RAM of the ECU 20. After that, the ECU 20 ends the current routine. On the other hand, if it is determined that the purge concentration is lower than the criterial concentration, the ECU 20 proceeds to step S15 to permit the correction coefficient from being modified and learned through sub F/B. After that, the ECU 20 ends the current routine.

As described above, according to the first embodiment of the invention, if it is determined that the purge concentration is equal to or higher than the criterial concentration, the correction coefficient is prohibited from being learned. Therefore, the correction coefficient can be prevented from being erroneously learned. Thus, the amount of fuel can be restrained from being erroneously corrected. Therefore, the exhaust emission properties of the engine 1 can be improved.

Incidentally, it is also appropriate to prohibit the correction coefficient from being modified through sub F/B in addition to learning the modified correction coefficient in step S14 of FIG. 2.

(Second Embodiment)

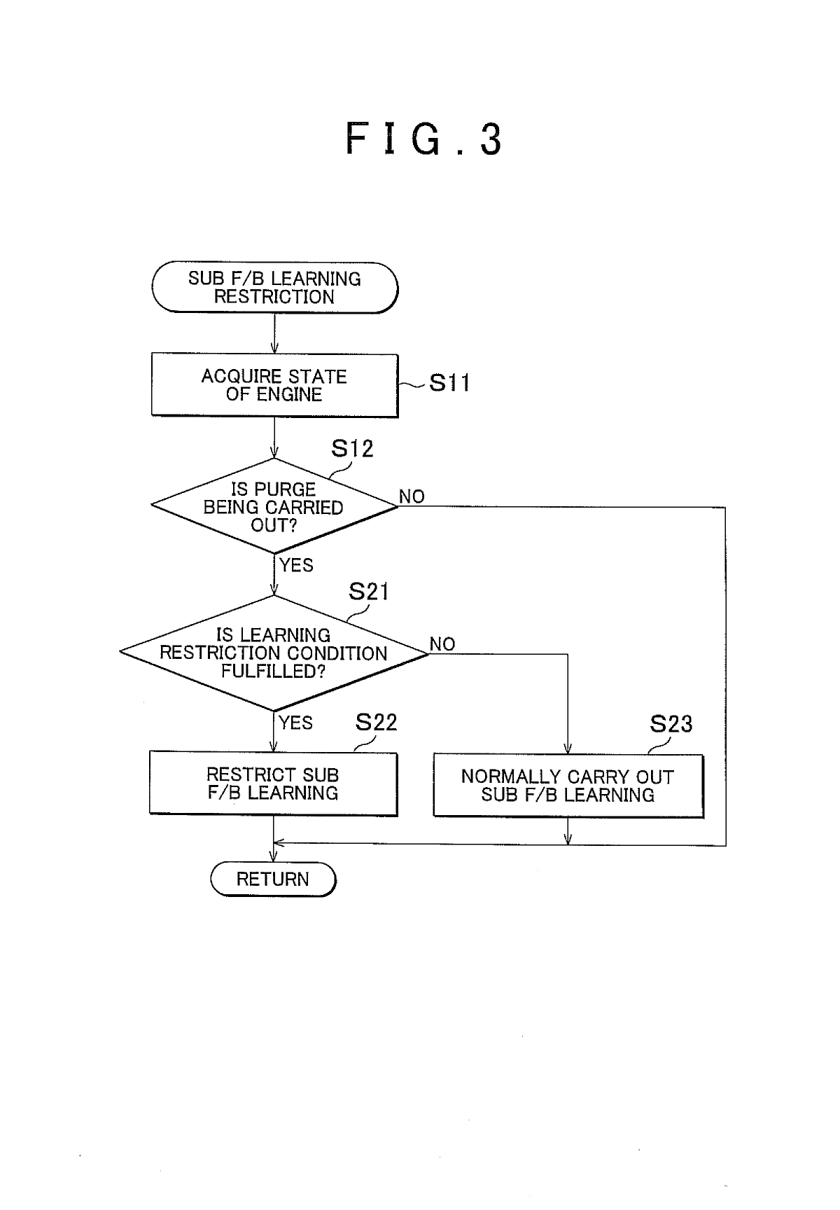

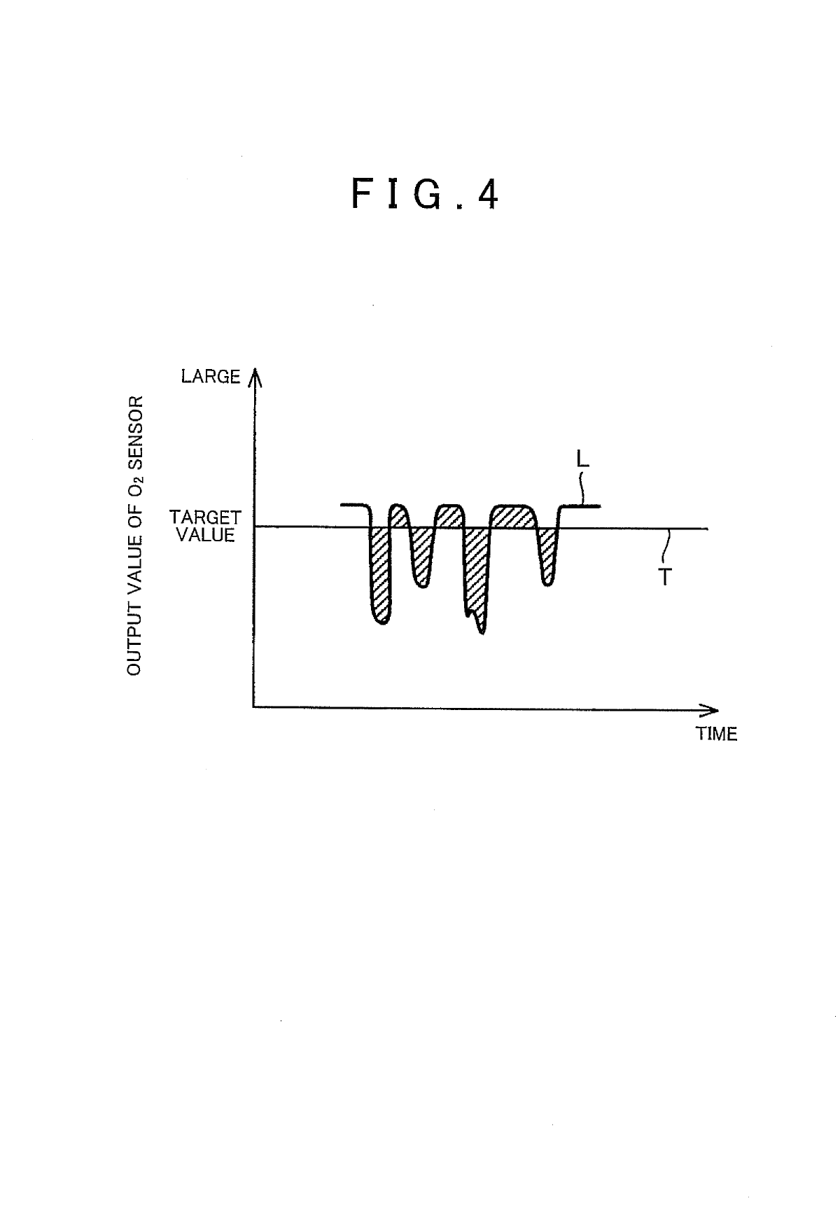

Next, an air-fuel ratio control apparatus according to the second embodiment of the invention will be described with reference to FIGS. 3 and 4. Incidentally, in this embodiment of the invention as well, FIG. 1 is referred to as far as the engine 1 is concerned. In this embodiment of the invention as well as the first embodiment of the invention, the ECU 20 calculates a basic fuel amount and carries out the aforementioned main F/B. Besides, the ECU 20 carries out sub F/B as well, but is different from the ECU 20 of the foregoing embodiment of the invention in that the speed of modification of the correction coefficient and the speed of the learning of the correction coefficient are changed in sub F/B. Sub F/B in this embodiment of the invention will be described hereinafter.

In sub F/B of this embodiment of the invention as well, the deviation between the output value of the O₂ sensor 9 and the target value is subjected to the PID processing to modify the correction coefficient. As is well-known, the integral term in the PID processing is integrated. The integrated value of this integral term may be referred to hereinafter as a time-integrated value. In this embodiment of the invention, the speed of change in this time-integrated value is changed in accordance with the difference between the output value of the O₂ sensor 9 and the target value. More specifically, if the difference between the output value of the O₂ sensor 9 and the target value is large, the integrated value added to the time-integrated value, namely, the update amount per each time is made large, and the number of times of update of the time-integrated value is increased. Thus, the speed of change in the time-integrated value becomes high. Besides, in this case, the speed of modification of the correction coefficient and the speed of the learning of the correction coefficient become high. On the other hand, if the difference between the output value of the O₂ sensor 9 and the target value is small, the update amount per each time is made small, and the number of times of update is reduced. Thus, the speed of change in the time-integrated value becomes low. In this case, the speed of modification of the correction coefficient and the speed of the learning of the correction coefficient become low. In this manner, in this embodiment of the invention, the speed of modification of the correction coefficient and the speed of the learning of the correction coefficient are changed in accordance with the difference between the output value of the O₂ sensor 9 and the target value.

In this embodiment of the invention as well, when purge gas with a high purge concentration is introduced into the intake passage 3 from the canister 11, the correction coefficient may be erroneously learned in sub F/B. Thus, the ECU 20 executes a sub F/B learning restriction routine shown in FIG. 3 to restrain the correction coefficient from being erroneously learned. This routine is repeatedly executed on a predetermined cycle during the operation of the engine 1. Incidentally, in FIG. 3, processes common to those of FIG. 2 are denoted by the same reference symbols respectively, and the description thereof is omitted.

In this routine, the same processes as in FIG. 2 are carried out until step S12. If it is determined that purge is being carried out at the moment, the ECU 20 proceeds to step S21 to determine whether or not a predetermined learning restriction condition is fulfilled. It is determined that the learning restriction condition is fulfilled, for example, if all the three conditions shown below are fulfilled. It is determined that the first condition is fulfilled if the purge concentration is equal to or higher than a predetermined criterial concentration. This determination may be made in the same manner as in the aforementioned step S13 of FIG. 2. It is determined that the second condition is fulfilled if the correction coefficient stored in the RAM of the ECU 20 at the moment is a correction coefficient that is learned when the purge concentration is low. It may be determined whether or not the correction coefficient stored in the RAM of the ECU 20 at the moment is a correction coefficient that is learned when the purge concentration is low, for example, by determining whether or not the canister 11 was being purged when the correction coefficient was learned last time. For example, if the correction coefficient stored in the RAM of the ECU 20 at the moment is a correction coefficient that is learned when the canister 11 is not being purged, it may be determined that the correction coefficient is learned when the purge concentration is low. Besides, if the output value of the O₂ sensor 9 is an output value that does not make it really necessary to correct the correction coefficient through sub F/B even in the case where the correction coefficient is learned when the canister 11 is being purged, it may be determined that the correction coefficient is learned when the purge concentration is low. It is determined that the third condition is fulfilled if the amount of deviation of the learning value in sub F/B is larger than a deviation criterial value. It may be determined whether or not the amount of deviation of the learning value in sub F/B is larger than a predetermined deviation criterial value, in accordance with the difference between the output value of the O₂ sensor 9 and the target value. FIG. 4 shows an example of how the output value of the O₂ sensor 9 changes with time when the canister 11 is being purged. Incidentally, a solid line L in the drawing indicates how the output value of the O₂ sensor 9 changes with time, and a solid line T indicates a target value. The sum of the differences between the output value of the O₂ sensor 9 and the target value is a value obtained by summating the areas of regions hatched in this drawing. Thus, the amount of deviation of the learning value is considered to be the summated value of the areas of the regions hatched in this drawing. Thus, it is appropriate to determine that the amount of deviation of the learning value is larger than the deviation criterial value if the summated value of the areas of the regions hatched in this drawing is equal to or larger than a preset criterial area. Incidentally, the criterial area may be appropriately set such that the correction coefficient is prevented from being erroneously learned in sub F/B.

If it is determined that the learning restriction condition is fulfilled, the ECU 20 proceeds to step S22 to restrict modification of the correction coefficient and the learning of the correction coefficient through sub F/B. In this process, modification of the correction coefficient and the learning of the correction coefficient may be restricted, for example, by reducing the number of times of update of the time-integrated value to prevent the speed of modification of the correction coefficient and the speed of the learning of the correction coefficient from becoming high, or modification of the correction coefficient and the learning of the correction coefficient may be restricted by limiting the update amount of the time-integrated value per each time to a small value. Besides, modification of the correction coefficient and the learning of the correction coefficient may be restricted by limiting both the number of times of update and the update amount. After that, the ECU 20 ends the current routine.

On the other hand, if it is determined that the learning restriction condition is not fulfilled, the ECU 20 proceeds to step S23 to modify and learn the correction coefficient through sub F/B as usual instead of restricting modification of the correction coefficient and the learning of the correction coefficient. Thus, in this process, the speed of change in the time-integrated value is changed, and the speed of modification of the correction coefficient and the speed of the learning of the correction coefficient are changed. After that, the ECU 20 ends the current control routine.

As described above, according to the second embodiment of the invention, if the learning restriction condition is fulfilled, modification of the correction coefficient and the learning of the correction coefficient through sub F/B are restricted. Therefore, the correction coefficient can be restrained from being erroneously corrected or learned. Thus, the amount of fuel can be restrained from being erroneously corrected, and the exhaust emission properties of the engine 1 can be improved.

The invention is not limited to the foregoing embodiments thereof, but can be carried out in various modes. For example, the internal combustion engine to which the invention is applied is not limited to a spark ignition-type internal combustion engine. The invention may also be applied to a diesel internal combustion engine. Besides, the invention is not limited to a port injection-type internal combustion engine having intake ports into which fuel is injected. The invention may be applied to a so-called direct injection-type internal combustion engine having cylinders into which fuel is directly injected.

The exhaust gas purifier that is provided in the exhaust passage is not limited to a three-way catalyst. An occlusion/reduction-type NOx catalyst or a particulate filter may be provided in the exhaust passage. The sensor provided upstream of the exhaust gas purification catalyst is not limited to an air-fuel ratio sensor, but may be an O₂ sensor. Besides, the sensor provided downstream of the exhaust gas purification catalyst is not limited to an O₂ sensor, but may be an air-fuel ratio sensor.

What is claimed is:

1. An air-fuel ratio control apparatus that is applied to an internal combustion engine having an intake passage to which a canister capable of retaining evaporative fuel generated in a fuel tank is connected via an evaporative fuel supply passage, and an exhaust passage that is provided with an exhaust gas purifier, the control apparatus comprising:
a first sensor that is provided in the exhaust passage in a section upstream of the exhaust gas purifier to acquire an air-fuel ratio of exhaust gas;
a second sensor that is provided in the exhaust passage in a section downstream of the exhaust gas purifier to acquire an air-fuel ratio of exhaust gas; and
a controller that corrects a fuel injection amount of the internal combustion engine through feedback on a basis of the air-fuel ratio acquired by the first sensor, modifies a correction coefficient used for feedback correction on a basis of the air-fuel ratio acquired by the second sensor, and has a storage unit that stores the modified correction coefficient, and prohibits the modified correction coefficient from being stored into the storage unit if a concentration of fuel in purge gas introduced into the intake passage from the canister is equal to or higher than a predetermined criterial concentration.

2. The air-fuel ratio control apparatus according to claim 1, wherein
the controller prohibits the correction coefficient from being modified if the concentration of fuel in purge gas introduced into the intake passage from the canister is equal to or higher than the criterial concentration.

3. An air-fuel ratio control apparatus that is applied to an internal combustion engine having an intake passage to which a canister capable of retaining evaporative fuel generated in a fuel tank is connected via an evaporative fuel supply passage, and an exhaust passage that is provided with an exhaust gas purifier, the control apparatus comprising:
a first sensor that is provided in the exhaust passage in a section upstream of the exhaust gas purifier to acquire an air-fuel ratio of exhaust gas;
a second sensor that is provided in the exhaust passage in a section downstream of the exhaust gas purifier to acquire an air-fuel ratio of exhaust gas; and
a controller that corrects a fuel injection amount of the internal combustion engine through feedback on a basis of the air-fuel ratio acquired by the first sensor, modifies a correction coefficient used for feedback correction on a basis of the air-fuel ratio acquired by the second sensor such that the air-fuel ratio acquired by the second sensor becomes equal to a predetermined target value, and has a storage unit that stores the modified correction coefficient, wherein
the controller restricts modification of the correction coefficient if a concentration of fuel in purge gas introduced into the intake passage from the canister is equal to or higher than a predetermined criterial concentration, the correction coefficient stored in the storage unit is the correction coefficient that is modified when the concentration of fuel in purge gas is lower than the criterial concentration, and a difference between the air-fuel ratio acquired by the second sensor and the target value is equal to or larger than a predetermined criterial value.

4. The air-fuel ratio control apparatus according to claim 3, wherein
the controller subjects at least a deviation between the air-fuel ratio acquired by the second sensor and the target value to an integration processing to modify the correction coefficient, and restricts modification of the correction coefficient by restricting at least one of the number of times of the integration processing and an update amount that is added each time in the integration processing.

5. A control method for an air-fuel ratio control apparatus that is applied to an internal combustion engine having an intake passage to which a canister capable of retaining evaporative fuel generated in a fuel tank is connected via an evaporative fuel supply passage, and an exhaust passage that is provided with an exhaust gas purifier, and that is equipped with a first sensor that is provided in the exhaust passage in a section upstream of the exhaust gas purifier to acquire an air-fuel ratio of exhaust gas, and a second sensor that is provided in the exhaust passage in a section downstream of the exhaust gas purifier to acquire an air-fuel ratio of exhaust gas, the control method comprising:
correcting a fuel injection amount of the internal combustion engine through feedback on a basis of the air-fuel ratio acquired by the first sensor,
modifying a correction coefficient used for feedback correction on a basis of the air-fuel ratio acquired by the second sensor such that the air-fuel ratio acquired by the second sensor becomes equal to a predetermined target value,
storing a storage unit with the modified correction coefficient,
determining whether or not a concentration of fuel in purge gas introduced into the intake passage from the canister is equal to or higher than a predetermined criterial concentration, the correction coefficient stored in the storage unit is the correction coefficient that is modified when the concentration of fuel in purge gas is lower than the criterial concentration, and a difference between the air-fuel ratio acquired by the second sensor and the target value is equal to or larger than a predetermined criterial value; and
restricting modification of the correction coefficient if it is determined that the concentration of fuel in purge gas introduced into the intake passage from the canister is equal to or higher than the predetermined criterial concentration, the correction coefficient stored in the storage unit is the correction coefficient that is modified when the concentration of fuel in purge gas is lower than the criterial concentration, and the difference between the air-fuel ratio acquired by the second sensor and the target value is equal to or larger than the predetermined criterial value.

6. The control method according to claim 5, wherein
at least a deviation between the air-fuel ratio acquired by the second sensor and the target value is subjected to an integration processing to modify the correction coefficient, and
at least one of the number of times of the integration processing and an update amount that is added each time in the integration processing is restricted.
